(19) United States
(12) Patent Application Publication
(10) Pub. No.: US 2009/0315782 A1
(43) Pub. Date: Dec. 24, 2009

(54) ANTENNA OF MOBILE PHONE

(75) Inventors: DA RUAN, SHANGHAI CITY (CN); DAVID HO, TAIPEI (TW)

Correspondence Address: BIRCH STEWART KOLASCH & BIRCH, PO BOX 747, FALLS CHURCH, VA, 22040-0747, US

(73) Assignee: INVENTEC APPLIANCES CORP.

(21) Appl. No.: 12/551,223

(22) Filed: Aug. 31, 2009

Related U.S. Application Data
(63) Continuation of application No. 11/508,856, filed on Aug. 24, 2006.

(30) Foreign Application Priority Data
Aug. 26, 2005 (TW) 94214786

(51) Int. Cl. H01Q 1/36

(52) U.S. Cl. 343/700 MS

(57) ABSTRACT

An antenna is embedded in a mobile phone and comprises a receiving sheet structure, a high frequency radiation part, a low frequency radiation part, and an extending part. The receiving sheet structure comprises a main body and a branch portion, and one end of said branch portion is connected to the main body and another end is connected to a curved part. Therefore one end of the high frequency radiation part is connected to a terminal of the curved part with a curved angle formed thereof, and another end of the high frequency radiation part is an open end and parallel to the branch portion. One end of the low frequency radiation part is connected to the main body, and another end of the low frequency radiation part is an open end. The extending part is connected to a terminal of the receiving sheet structure, and perpendicularly extended to the terminal of the receiving sheet structure.

This application is a Continuation of co-pending application Ser. No. 11/508,856, filed on Aug. 24, 2006, which claims priority under 35 U.S.C. § 119 to TW 94214786, filed on Aug. 26, 2005. The entire contents of each of the above-identified application are hereby incorporated by reference.

### FIELD OF THE INVENTION

The present invention generally relates to an antenna of a mobile phone, and more particularly to an antenna structure that can reduce the room inside the mobile phone.

### DESCRIPTION OF THE RELATED ART

With the wireless communication technique progressing rapidly, all kinds of the communication products as dual-band module, three-band module, and even multi-frequencies module are applied to be a tendency. There are very important factors as efficacy, appearance, and dimensions of a product to become a popular one in the market. Under the condition of the volume of a mobile phone being smaller, how to reach the condition is an important issue of the persons skilled in the art.

The receiving effect of the mobile phone mainly relies on an antenna. The antenna can be differentiated between a hidden antenna and an exposed antenna. The hidden antenna has the merits of not easily broken and artistic appearance. Therefore, to effectively use the room inside the mobile phone for accommodating the hidden antenna may be an important tendency of the design.

In the present mobile phone marketing, a planar inverter-F antenna of the hidden plan antenna is a main stream. Since the antenna has a simple structure and is easy to be designed. Therefore, the planar inverter-F antenna is widely applied to the field of the mobile phone. On the other hand, the planar inverter-F antenna only has a single operation frequency, in case it is applied to the dual-band mobile phone, it usually needs the dual-planar inverter-F antenna to receive the electromagnetic waves of 900 MHz and 1800 MHz. Even more, the function of receiving the 1900 MHz is added to the newly generated mobile phone and becomes a three-band mobile phone. With the limited shape and the dimensions of the planar inverter-F antenna, the planar inverter-F antenna cannot be applied to the 1900 MHz. Therefore, the planar inverter-F antenna is not suitable for the three-band mobile phone. Comparatively adding the length of the planar inverter-F antenna to increase the frequency response is an opposite way to the tendency of a small volume of the mobile phone.

Hence, the inventor has aimed some factors to bring up a suitable antenna for a new generation of a mobile phone.

### SUMMARY OF THE INVENTION

The primary object of the present invention is to provide an antenna of a mobile phone that can reduce the room inside the mobile phone .

The antenna of the mobile phone of the present invention comprises an receiving sheet structure, a high frequency radiation part, a low frequency radiation part, and an extending part. The antenna is a sheet structure. The receiving sheet structure comprises a main body and a branch portion. The branch portion comprises a flat strip, a curved part, and a plate. One end of the flat strip is connected to the main body, and another end is connected to the curved part. Another end of the curved part is connected to the plate. The plate has a gap. The curved part has a round hole so as to allow a hot melt column of a crutch of the antenna to pass through, and is firmed to another component inner the mobile phone.

One end of the high frequency is an open end, and another end is connected to an terminal of the curved part. A curved angle is formed at the connection of the open end and the terminal and the state of three dimensions. The extending direction of the high frequency radiation part is parallel to the direction of the flat strip of the branch portion. And one end of the low frequency radiation part is connected to the main body of the receiving sheet structure, and another end is an open end formed as a flat strip shape parallel to the branch portion. Besides, a side adjacent to the terminal of the receiving sheet structure is formed an extending part, the extending part perpendicularly extends into the receiving sheet structure. And the terminal of the extended part is curved and formed an outward arc-round sheet by way of machining, and a surface of the arc-round sheet has a protruding dot so as to contact to a circuit board. The terminal of the receiving sheet structure is formed a round hole therein as well.

In the present invention, the high frequency radiation part is DCS (Digital Cellular System) 1800 MHz; the low frequency radiation part is GSM (Global System for Mobile Communications) 900 MHz. And the low frequency radiation part, a high frequency radiation part, and the receiving sheet structure form an electric circuit.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a three-dimensional view of a preferred antenna of the mobile phone according to the present invention;

FIG. 2 shows a vertical view of a preferred antenna of the mobile phone according to the present invention;

FIG. 3 shows a front side view of a preferred antenna of the mobile phone according to the present invention; and

FIG. 4 shows a left side view of a preferred antenna of the mobile phone according to the present invention.

### DETAILED DESCRIPTIONS OF THE PREFERRED EMBODIMENTS

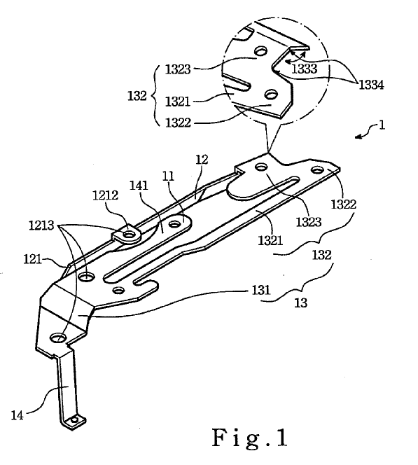

Please refer to FIGS. 1 to 4, which illustrate schematic views of an antenna 1 of the present invention. The antenna 1 is applied to a mobile phone and has a low frequency radiation part 12, a high frequency radiation part 11, a receiving sheet structure 13, and an extending part 14. The antenna 1 is a sheet structure. The receiving sheet structure 13 has a main body 131 and a branch portion 132. The branch portion 132 has a flat strip 1321, a curved part 1322, and a plate 1323. One end of the flat strip 1321 is connected to the main body 131, and another end of the curved part 1322 is connected to the plate 1323. An outside edge of the plate 1323 has a gap. The curved part 1322 and the main body 131 have a plurality of round holes 1213.

One end of the high frequency radiation part 11 is an open end 121, and another end is connected to the terminal of the curved part 1322 formed a curved angle 1333 between the connection thereof, and the curved angle 1333 is between 15 to 20 degrees as a three-dimensional structure so as to let the antenna 1 be a more planar structure with a smaller room. The high frequency radiation part 11 is parallel to the flat strip 1321 of the branch portion 132 so as to make the antenna 1 occupy smaller room. A hemicycle sheet 1212 is formed on an interior of a side edge of the high frequency radiation part 11 and near the open end 121, the hemicycle sheet 1212 has a round hole 1213 therein so as to allow a hot melting column of a crutch of the antenna to pass through, and is firmed to another component inner the mobile phone.

One end of the low frequency radiation part 12 is connected to the main body 131 of the receiving sheet structure 13, and another end is an open end, which the whole structure is a U shape sheet with the appearance of a strip parallel to the branch portion 132. An upper part of the low frequency radiation part 12 is curved downward about 70 degrees for closing an upper edge of the main body 131 and between the high frequency radiation part 11 and the branch portion 132. A U-sharp indent is formed at a position comparative to one side of the hemicycle sheet 1212 of the high frequency radiation part 11. Another round hole 1213 is also formed in the terminal of the open end. The connection of the U-sharp indent and the main body 131 is formed the third round hole 1213.

The extending part 14 is formed near a side of the terminal of the receiving sheet structure 13 and perpendicularly downward extended to the receiving sheet structure 13. And an arc-round plate 141 is curved and outward the terminal of the extended part by way of machining, and a surface of the arc-round plate 141 has a protruding dot so as to contact to a circuit board. The terminal of the receiving sheet structure 13 is formed a round hole 1213 therein as well.

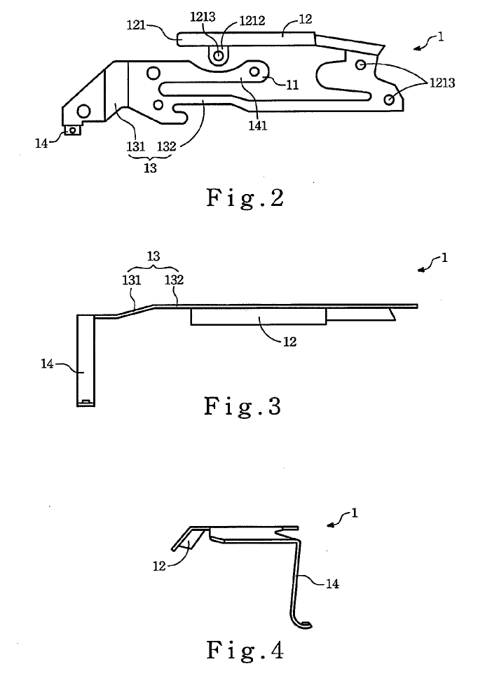

As shown form from FIG. 1 to FIG. 4, FIG. 1 illustrates a three-dimensional view of a preferred antenna of the mobile phone in according to the present invention; FIG. 2 illustrate a top view of a preferred antenna of the mobile phone; FIG. 3 illustrates a front view of the preferred antenna of the mobile phone; FIG. 4 illustrates a left side view of the preferred antenna of the mobile phone.

In an embodiment of the antenna in accordance with the present invention. As shown in the figures, the main body of the antenna connects to a crutch of the antenna by hot melting. For the purpose of fully utilizing the room, two continuous curves 1334 are made between the receiving sheet structure 13 and the high frequency radiation part 11 so as to let the receiving sheet structure 13 is parallel to the high frequency radiation part 11 of the antenna.

Such design can save the room for the three-dimensional structure which is more than the room for the plan structure. The high frequency radiation and the low frequency radiation part of the antenna are individually designed for the frequencies of DCS1800 MHz and GSM900 MHz. The low frequency radiation part is formed as a plan U-shape, and the end is bent downward to close the upper edge of the branch portion. The high frequency radiation is formed as a strip wider than the low frequency radiation.

The receiving sheet structure of the antenna, the high frequency radiation part, and the low frequency radiation part form an electric circuit. By adjusting the high frequency radiation part and the low frequency radiation part, the antenna can receive or transmit signals of the two bands. By adjusting the length and the width of the high frequency radiation part, the antenna can be in resonance at the high frequency band and gain a lower standing wave ratio. For coordinating the wavelength, the resonance point, and the length of the radiation part, the low frequency radiation part must be curved as a U-shape to reduce the transverse length, and the upper part of the low frequency radiation part is downward curved 70 degrees in order to reduce the whole width of the antenna. Adjusting appropriately the ratio of the width, the length, and the size for the upper and the lower parts of the low frequency radiation part, the resonance point of the low frequency radiation part of the antenna has a smaller value of standing wave ratio so as to reduce the reflection. Hence, the high frequency radiation part and the low frequency radiation part are connected to the import end through a transmission line, and then by way of adjusting the length of the transmission line, it can achieve the impedance matching of the antenna so as to lower the resonance point of the two bands and reduce the standing wave ratio. Then it can raise the radiation efficiency and effectively control the SAR(Specific Absorption Rate) value. Due to the space limitation, the way of the small-angle curvature of the transmission line makes the length thereof meet the needs.

In the preferred embodiment, the antenna is made of the copper. To assure the transmission performance, the surface of the antenna is plated with the gold.

Hence, with the development of the mobile phone technology, versatile functions may be a must so as to drive the development for the new generation of antenna. As the purpose of the mobile phone being easily carried, the present invention provides a miniaturized hidden antenna for two bands of GSM and DCS, which realizes the cost reduction, mass-produce, and stable property.

As a conclusion, the three-dimensional sheet of the antenna of the present invention can be laid out according to the configuration of the mobile phone so as to improve the disadvantage of the shape of the planar inverter-F antenna with a larger volume in prior arts and improve the circuit structure of the high-frequency antenna to increase the responsive bandwidth. Therefore, the dual-band or the multi-band is able to enhance the community performance of the mobile phone.

What is claimed is:

1. An antenna applied to a mobile phone, comprising:
a receiving sheet structure for receiving electromagnetic waves comprising a main body and a branch portion, a flat strip of said branch portion is connected at one end to the main body and at another end to a curved part of said branch portion;
a high frequency radiation part substantially parallel to the strip of the branch portion, the high frequency radiation part comprising a first open end and another end connected to a terminal of the curved part with a curved angle formed between the high frequency radiation part and the terminal;
a low frequency radiation part comprising a second open end and another end connected to the main body, the low frequency radiation part disposed substantially parallel to the strip of the branch portion and between the high frequency radiation part and the branch portion; and
an extending part connected to the main body of the receiving sheet structure and extending downwards in a perpendicular direction with respect to the main body;
wherein the low frequency radiation part, the high frequency radiation part, the receiving sheet structure form an electric circuit.

2. The antenna according to claim 1, wherein said antenna is essentially a sheet structure.

3. The antenna according to claim 2, wherein said antenna is made of copper.

4. The antenna according to claim 1, wherein said curved part further comprises a plate, and connects to the high frequency radiation part through the plate.

5. The antenna according to claim 1, wherein a terminal of the high frequency radiation part has a round hole on an edge thereof for connecting to a circuit.

6. The antenna according to claim 1, wherein a terminal of the extending part comprises a curved strip having a dot protruding from a surface of the curved strip.

7. The antenna according to claim 1, wherein said high frequency radiation part is designed for radiation at the frequency of DCS (Digital Cellular System) 1800 MHz.

8. The antenna according to claim 1, wherein said low frequency radiation part is designed for radiation at the frequency of GSM (Global System for Mobile Communications) 900 MHz.

9. The antenna according to claim 1, wherein said low frequency radiation part, the high frequency radiation part, the receiving sheet structure, and the extending part form an electric circuit.
